(19) United States
(12) Patent Application Publication
(10) Pub. No.: US 2025/0117731 A1
(43) Pub. Date: Apr. 10, 2025

(54) METHODS AND APPARATUS FOR CALCULATING AND DISPLAYING PRODUCTIVITY LEVERAGE DATA

(71) Applicant: Benjamin Traub, Englewood, FL (US)

(72) Inventor: Benjamin Traub, Englewood, FL (US)

(73) Assignee: Inspira AI Corp, Las Vegas, NV (US)

(21) Appl. No.: 18/907,620

(22) Filed: Oct. 7, 2024

Related U.S. Application Data
(60) Provisional application No. 63/588,689, filed on Oct. 7, 2023.

(51) Int. Cl. G06Q 10/0639

(52) U.S. Cl. CPC G06Q 10/0639

(57) ABSTRACT

The present invention relates to a computerized method for calculating and displaying data related to the Productivity Leverage Data and the related ratio, which describes how many human-equivalent minutes of work are output by autonomous, computerized Agents, for every minute of human input. Useful for monitoring how impactful the related productivity is, derived from automation.

### BACKGROUND

The present invention generally relates to reporting on business productivity and business intelligence.

Computerized systems which are automated are capable of automatically performing tasks that might alternatively be performed by a human.

While the performed tasks are carried out autonomously, they have a human-equivalent value, based on how long it would have taken a human to do that same work.

A novel way to evaluate the effectiveness of automation is to consider the “Productivity Leverage Ratio.” This metric quantifies the efficiency gains by comparing the human minutes saved through automation to the human minutes spent overseeing it.

### SUMMARY OF INVENTION

The present invention incorporates a computerized method for reporting on the number of human-equivalent man hours which are saved through automation, and to generate a ratio where the human time to directly facilitate the automation is compared with the minutes saved.

According to an aspect of the present invention, there is a database table of autonomous tasks that can be performed by the automated systems.

According to another aspect of the present invention, the table of autonomous tasks includes the number of minutes or hours that it would generally take a human to perform the same task.

According to another aspect of the present invention, the table of autonomous tasks includes the number of minutes or hours that it would generally take a human to plan or otherwise facilitate the automation to run and for the human to perform any additional collaboration to complete the task.

According to another aspect of the present invention, there is another table that stores the record of each time a particular automation runs.

According to another aspect of the present invention, a computerized system may calculate business intelligence reports on metrics surrounding the automation, including the total number of times an automation has been processed, the number of human-equivalent minutes saved.

### BRIEF DESCRIPTION OF THE DRAWINGS

FIG. 1 illustrates a database table used to store a list of automations that might be executed, where there is a unique ID 1 and an automation_name 2 with the estimated number of Human-input-minutes 3 required by humans to plan and oversee the automation, and human-equivalent-output-minutes 4 that is generated each time the automation runs. Records are stored in the table 5,6 which may be used to calculate reports.

FIG. 2 illustrates a database table used to store a record each time an automation is executed, where there is a unique ID 1 and an automation_id 2 with the quantity of executions 9 that are run for a particular automation_id 8. There is a date and time 10 of the execution. Each time an automation is executed, whether singularly or in plural, a record 11, 12, 14, 14 is stored in the table which may be used to calculate reports.

FIG. 3 illustrates a report where the minutes worked by humans 16 and the human equivalent minutes worked by agents 17 are made visible, for a selected date range 15. A productivity leverage ratio, or “PLR” 18 is displayed, derived from the human minutes being divided into human equivalent minutes to generate a ratio that indicates how much leverage of time was realized through the use of automated agents.

FIG. 4 illustrates a report where the minutes worked by humans 16 and the human equivalent minutes worked by agents 17 are made visible, for a selected date range 15. The total minutes saved 19 through automation is calculated.

FIG. 5 illustrates the computerized system for capturing the data and processing it ito reports.

### DETAILED DESCRIPTION

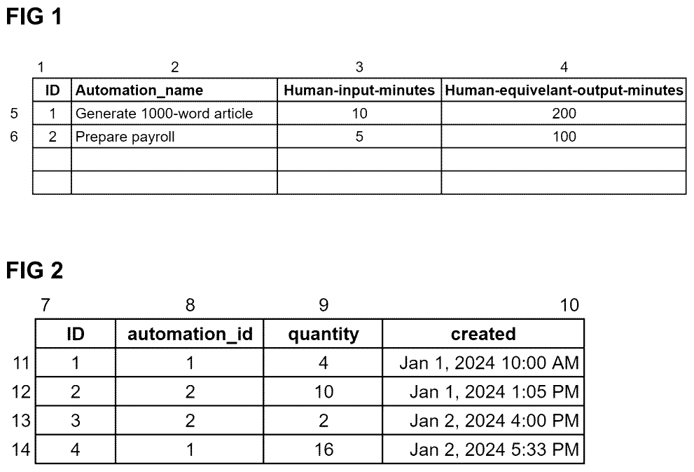

FIG. 1 illustrates a database table used to store a list of automations that might be executed, where there is a unique ID 1 and an automation_name 2 with the estimated number of Human-input-minutes 3 required by humans to plan and oversee the automation, and human-equivalent-output-minutes 4 that is generated each time the automation runs. Records are stored in the table 5,6 which may be used to calculate reports.

In one embodiment, there exists a database table is used to store a list of automations that are available to be executed, where there is a unique ID 1 and an automation_name 2 with the estimated number of Human-input-minutes 3 required by humans to plan and oversee the automation, and human-equivalent-output-minutes 4 that is generated each time the automation runs. Records are stored in the table 5,6 which may be used to calculate reports.

FIG. 2 illustrates a database table used to store a record each time an automation is executed, where there is a unique ID 1 and an automation_id 2 with the quantity of executions 9 that are run for a particular automation_id 8. There is a date and time 10 of the execution. Each time an automation is executed, whether singularly or in plural, a record 11, 12, 14, 14 is stored in the table which may be used to calculate reports.

In one embodiment, there exists a database table used to store a record each time an automation is executed, where there is a unique ID 1 and an automation_id 2 with the quantity of executions 9 that are run for a particular automation_id 8. There is a date and time 10 of the execution. Each time an automation is executed, whether singularly or in plural, a record 11, 12, 14, 14 is stored in the table which may be used to calculate reports.

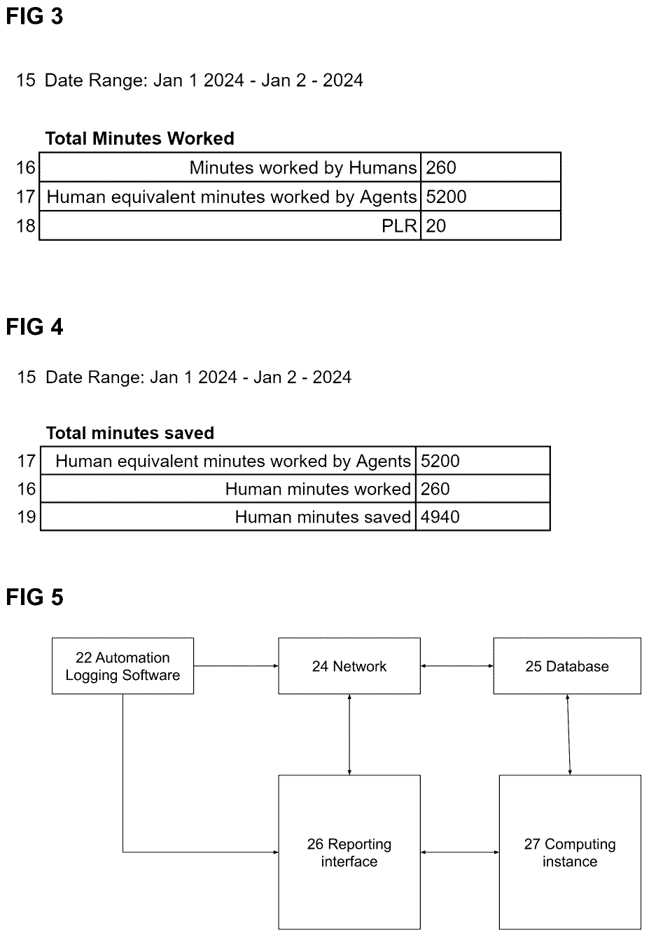

FIG. 3 illustrates a generated report where the minutes worked by humans 16 and the human equivalent minutes worked by agents 17, for a selected date range 15. A productivity leverage ratio, or “PLR” 18 is displayed, derived from the human minutes being divided into human equivalent minutes to generate a ratio that indicates how much leverage of time was realized through the use of automated agents.

In one embodiment, a report is generated where the minutes worked by humans 16 and the human equivalent minutes worked by agents 17 are made visible, for a selected date range 15. A productivity leverage ratio, or “PLR” 18 is displayed, derived from the human minutes being divided into human equivalent minutes to generate a ratio that indicates how much leverage of time was realized through the use of automated agents.

In another embodiment, a report is generated where the minutes worked by humans 16 and the human equivalent minutes worked by agents 17 are made visible, for a selected date range 15, and the minutes are converted into a different measure of time, such as hours. A productivity leverage ratio, or “PLR” 18 is displayed, derived from the human time being divided into human equivalent time to generate a ratio that indicates how much leverage of time was realized through the use of automated agents.

FIG. 4 illustrates a generated report where the minutes worked by humans 16 and the human equivalent minutes worked by agents 17, for a selected date range 15.

FIG. 4 illustrates a report where the minutes worked by humans 16 and the human equivalent minutes worked by agents 17 are made visible, for a selected date range 15. The total minutes saved 19 through automation is calculated, derived by subtracting the human minutes from the human equivalent minutes indicating how much time was saved through the use of automated agents.

In one embodiment, a report is generated where the minutes worked by humans 16 and the human equivalent minutes worked by agents 17 are made visible, for a selected date range 15. The total minutes saved 19 through automation is calculated, derived by subtracting the human minutes from the human equivalent minutes indicating how much time was saved through the use of automated agents.

In another embodiment, a report is generated where the minutes worked by humans 16 and the human equivalent minutes worked by agents 17 are converted into a different measure of time, such as hours. The total time saved 19 through automation is calculated, derived by subtracting the human time from the human equivalent time indicating how much time was saved through the use of automated agents.

FIG. 5 illustrates the computerized system for storing the data and generating reports.

In one embodiment, external logging software 22 transmits log data through a network to the database 25. The reporting interface 26, executed by the computing instance 27 comprised of standard computing resources such as CPU, memory and storage, retrieves and compiles the records from the database 25 through a network 24 to display it in the reporting interface 26.

In another embodiment, external logging software 22 transmits log data through a network to the database 25. The reporting interface 26, executed by the computing instance 27 comprised of standard computing resources such as CPU, memory and storage, retrieves and compiles the records from the database 25 through a network 24 to send it to parties using email or other messaging channels.

What is claimed is:

1. A computerized method for displaying productivity leverage data, comprising:
Storing, in a database, a list of autonomous tasks, each task having:
A unique identifier, and
An estimated number of human input minutes required to oversee or plan the execution of the task, and
An estimated number of human-equivalent output minutes representing the time that would have been required for a human to perform the same task, and
Storing, in a database, records of each execution of an autonomous task, wherein each record includes:
The unique identifier of the autonomous task, and
The number of executions performed, and
A timestamp corresponding to the execution, and
Calculating a productivity leverage ratio (PLR) by dividing the sum of human-equivalent output minutes by the sum of human input minutes over a defined period of time, and
Generating and displaying a report that includes the productivity leverage ratio (PLR), the total human-equivalent output minutes, and the total human input minutes for the defined period.

2. The method of claim 1, further comprising:
Calculating a total time saved by subtracting the total human input minutes from the total human-equivalent output minutes for the defined period; and
Displaying the total time saved in the report.

3. The method of claim 1, wherein the report is generated for a user-selected date range, and wherein the productivity leverage ratio (PLR) and the total time saved are calculated for the selected date range.

4. The method of claim 1, further comprising:
Converting the human input minutes and human-equivalent output minutes into a different time unit, such as hours, prior to generating the report.

5. The method of claim 1, wherein the measure of time is updated dynamically each time the report is generated in real-time based on the updated data.

6. The method of claim 1, wherein the database includes a plurality of tables, including:
A first table for storing the list of autonomous tasks with their unique identifiers and estimated time values; and
A second table for storing records of each execution of the autonomous tasks, including the unique identifier, number of executions, and timestamp, and
A system for displaying productivity leverage data, comprising:
A database for storing a list of autonomous tasks and records of each execution of an autonomous task, wherein each autonomous task is associated with an estimated number of human input minutes and human-equivalent output minutes, and
A computing device configured to:
Retrieve the list of autonomous tasks and execution records from the database;
Calculate a productivity leverage ratio (PLR) by dividing the human-equivalent output minutes by the human input minutes, and
Generate a report comprising the productivity leverage ratio (PLR), total human input minutes, and total human-equivalent output minutes for a defined time period; and
Display the generated report on a user interface.

7. The system of claim 7, wherein the computing device is further configured to:
Calculate the total time saved by subtracting the total human input minutes from the total human-equivalent output minutes; and
Include the total time saved in the generated report.

8. The system of claim 7, wherein the computing device is further configured to:
Allow a user to select a date range for the report, and to calculate the productivity leverage ratio (PLR) and total time saved based on the selected date range.

9. The system of claim 7, wherein the computing device is further configured to:
Convert human input minutes and human-equivalent output minutes into other time units, such as hours, prior to generating the report.

10. The system of claim 7, further comprising:
An external logging software that transmits log data through a network to the database, wherein the computing device retrieves and compiles the data for generating the report, and
A non-transitory computer-readable medium storing instructions that, when executed by a computing device, cause the computing device to perform the method of claim 1.
